(19) United States
(12) Patent Application Publication
(10) Pub. No.: US 2018/0232152 A1
(43) Pub. Date: Aug. 16, 2018

(54) GATED END-TO-END MEMORY NETWORK

(71) Applicant: Xerox Corporation, Norwalk, CT (US)

(72) Inventors: Julien Perez, Grenoble (FR); Fei Liu, Point Cook (AU); Scott Peter Nowson, Monkstown (IE)

(21) Appl. No.: 15/429,344

(22) Filed: Feb. 10, 2017

(51) Int. Cl. G06F 3/06

(52) U.S. Cl. CPC G06F 3/0607; G06F 3/068; G06F 3/0634

(57) ABSTRACT

A method and apparatus for gating an end-to-end memory network are disclosed. For example, the method includes receiving a question as an input, calculating an updated state of a memory controller by applying a gate mechanism to an output based on the input and a current state of the memory controller of the end-to-end memory network, wherein the updated state of the memory controller determines a next read operation of a memory cell of a plurality of memory cells in the end-to-end memory network, repeating the calculating for a pre-determined number of hops and predicting an answer to the question by applying a softmax function to a sum of the output and the state of the memory controller of each one of the pre-determined number of hops.

### BACKGROUND

Machine learning can be used to train machines to answer complex questions. Examples of machine learning may include neural networks, natural language processing, and the like.

Machine learning can be used for a particular application such as machine reading. Machine reading using differentiable reasoning models has recently shown remarkable progress. In this context, end-to-end trainable memory networks have demonstrated promising performance on simple natural language based reasoning tasks such as factual reasoning and basic deduction.

However, other tasks, namely multi-fact question-answering, positional reasoning or dialog related tasks, remain challenging. The other tasks remain particularly due to the necessity of more complex interactions between the memory and controller modules composing this family of models.

### SUMMARY

According to aspects illustrated herein, there are provided a method, non-transitory computer readable medium and apparatus for regulating access in a gated end-to-end memory network. One disclosed feature of the embodiments is a method that receives a question as an input, calculates an updated state of a memory controller by applying a gate mechanism to an output based on the input and a current state of the memory controller of the gated end-to-end memory network, wherein the updated state of the memory controller determines a next read operation of a memory cell of a plurality of memory cells in the gated end-to-end memory network, repeats the calculating for a pre-determined number of hops and predicts an answer to the question by applying a softmax function to a sum of the output and the state of the memory controller of each one of the pre-determined number of hops.

Another disclosed feature of the embodiments is a non-transitory computer-readable medium having stored thereon a plurality of instructions, the plurality of instructions including instructions which, when executed by a processor, cause the processor to perform operations that receive a question as an input, calculate an updated state of a memory controller by applying a gate mechanism to an output based on the input and a current state of the memory controller of the gated end-to-end memory network, wherein the updated state of the memory controller determines a next read operation of a memory cell of a plurality of memory cells in the gated end-to-end memory network, repeat the calculating for a pre-determined number of hops and predict an answer to the question by applying a softmax function to a sum of the output and the state of the memory controller of each one of the pre-determined number of hops.

Another disclosed feature of the embodiments is an apparatus comprising a processor and a computer-readable medium storing a plurality of instructions which, when executed by the processor, cause the processor to perform operations that receive a question as an input, calculate an updated state of a memory controller by applying a gate mechanism to an output based on the input and a current state of the memory controller of the gated end-to-end memory network, wherein the updated state of the memory controller determines a next read operation of a memory cell of a plurality of memory cells in the gated end-to-end memory network, repeat the calculating for a pre-determined number of hops and predict an answer to the question by applying a softmax function to a sum of the output and the state of the memory controller of each one of the pre-determined number of hops.

### BRIEF DESCRIPTION OF THE DRAWINGS

The teaching of the present disclosure can be readily understood by considering the following detailed description in conjunction with the accompanying drawings, in which:

FIG. 1 illustrates an example system of the present disclosure;

FIG. 2 illustrates a visual example of gating an end-to-end memory network the present disclosure;

FIG. 3 illustrates a flowchart of an example method for regulating access in a gated end-to-end memory network; and

FIG. 4 illustrates an example high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses a gated end-to-end memory network. As discussed above, machine reading using differentiable reasoning models has recently shown remarkable progress. In this context, end-to-end trainable memory networks have demonstrated promising performance on simple natural language based reasoning tasks such as factual reasoning and basic deduction.

However, other tasks, namely multi-fact question-answering, positional reasoning or dialog related tasks, remain challenging. The other tasks remain challenging particularly due to the necessity of more complex interactions between the memory and controller modules composing this family of models.

The embodiments of the present disclosure provide an improvement to existing end-to-end memory networks by gating the end-to-end memory network. Gating provides an end-to-end memory network access regulation mechanism that uses a short-cutting principle. The gated end-to-end memory network of the present disclosure improves the existing end-to-end memory network by eliminating the need for additional supervision signals. The gated end-to-end memory network provides significant improvements on the most challenging tasks without the use of any domain knowledge.

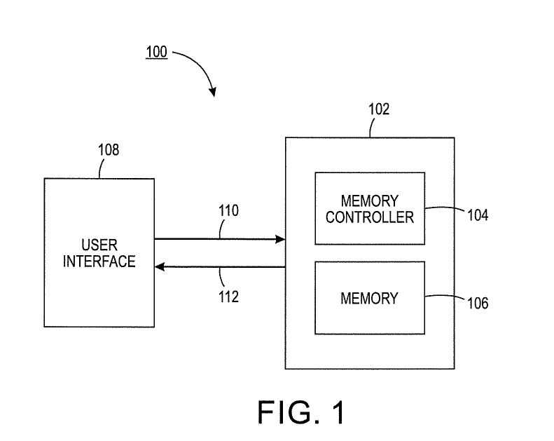

FIG. 1 illustrates an example system 100 of the present disclosure. In one example, the system 100 may include a dedicated application server 102 (also referred to as AS 102). The dedicated AS 102 may be an end-to-end trainable memory network that can perform natural language performance reasoning tasks, such as for example, factual reasoning, basic deduction, multi-fact question-answering, positional reasoning, dialog related tasks, and the like.

In one embodiment, the system 100 may include a user interface (UI) 108. The UI 108 may be a user interlace of the dedicated AS 102 or a separate computing device that is directly connected to, or remotely connected to, the dedicated AS 102. In one embodiment, the UI 108 may provide an input 110 (e.g., a question or query) and the dedicated AS 102 may produce an output 112 (e.g., a predicted answer to the question or query). For example, the input 110 may ask “What language do they speak in France?” and the output 112 may be “French.”

In one embodiment, the dedicated AS 102 may include a memory controller 104 and a memory 106. In one embodiment, the memory controller 104 may control how the memory 106 is accessed and what is written into the memory 106 to produce the output 112. In one embodiment, the memory 106 may be a gated end-to-end memory network or a gated version of a memory-enhanced neural network.

In one embodiment, the memory 106 may comprise supporting memories that are comprised of a set of input and output memory representations with memory cells. The input and output memory cells may be denoted by mᵢ and cᵢ, respectively. The input memory cells mᵢ and the output memory cells cᵢ may be obtained by transforming a plurality of input contexts (or stories) x₁, . . . , xᵢ using two embedding matrices A and C. The plurality of input contexts may be stored in the memory 106 and used to train the memory controller 104 to perform a prediction of an answer to the question.

In one embodiment, the input contexts may be defined to be any context that makes sense. In a simple example, the context may be defined to be a window of words to the left and to the right of a target word. Thus, for the example a supportive memory input of “My name is Sam” could have a data set of ([My, is], name) and ([name, Sam], is) of (context, target).

In one embodiment, the embedding matrices A and C may both have a size d×|V|, where d is the embedding size and |V| is the vocabulary size. In one embodiment, the embedding matrices A and C may be pre-defined based on values obtained from training using a training data set. The embedding matrix A may be applied to xᵢ such that mᵢ=Aφ(xᵢ), where φ( ) is a function that maps the input into a bag of dimensions equivalent to the vocabulary size |V|. The embedding matrix C may be applied to xᵢ such that cᵢ=Cφ(xᵢ).

In one embodiment, the input 110, or a question q may be encoded using another embedding matrix, B ∈ [symbol] ^{d×|V|}, resulting in a question embedding u=Bφ(q). In one embodiment, u may also be referred to as a state of the memory controller 104.

In one embodiment, the input memories (mᵢ), together with the embedding of the question u, may be utilized to determine the relevance of each of the input contexts x₁, . . . , xᵢ yielding a vector of attention weights given by Equation (1) below:

$${p}_{i} = softmax ( {u}^{T} {m}_{i} ) , where softmax ( {a}_{i} ) = \frac{{e}^{{a}_{i}}}{{\sum }_{j ∈ [ 1 , n ]} {e}^{{a}_{i}}} . \qquad Equation ( 1 )$$

Subsequently, the response, or output, o, from the output memory may be constructed by the weighted sum shown in Equation (2) below:

o=Σᵢpᵢcᵢ Equation (2)

In some embodiments, for more difficult tasks that require multiple supporting memories, the model can be extended to include more than one set of input/output memories by stacking a number of memory layers. In this setting, each memory layer may be named a hop and the (k+1)^{th} hop may take as an input the output of the k^{th} hop as shown by Equation (3) below:

u^{k+1}=o^{k}+u^{k}, Equation (3)

where u^{k} may be a current state and u^{k+1} may be an updated state.

In one embodiment, the final step to the predicting an answer (e.g., the output 112) for the question (e.g., the input 110) may be performed by Equation (4) below:

â=softmax(W(o^{K}+u^{K})), Equation (4)

where â is the predicted answer distribution, W ∈ [symbol] ^{|V|×d} is a parameter matrix for the model to learn and K is the total number of hops.

One embodiment of the present disclosure applies a gate mechanism to Equation (3) to improve the performance of Equation (4). For example, by applying a gate mechanism to Equation (3), Equation (4) may be used to accurately perform more complicated tasks such as multi-fact question answering, positional reasoning, dialog related tasks, and the like.

In one embodiment, the gate mechanism may dynamically regulate the interaction between the memory controller 104 and the memory 106. In other words, the gate mechanism may learn to dynamically control the information flow based on a current input. The gate mechanism may be capable of dynamically conditioning the memory reading operation on the state u^{k} of the memory controller 104 at each hop k.

In one embodiment, the gate mechanism T^{k}(u^{k}) may be given by Equation (5) below:

T^{k}(u^{k})=σ(W_{T}^{k}u^{k}+b_{T}^{k}), Equation (5)

where σ is a vectorization sigmoid function, W_{T}^{k} is a hop-specific parameter matrix, b_{T}^{k} is a bias term for the k^{th} hop and T^{k}(x) is a transform gate for the k^{th} hop. The vectorization sigmoid function may be a mathematical function having and “S” shaped curve. The vectorization sigmoid function may be used to reduce the influence of extreme values or outliers in the data without removing them from the data set. The gate mechanism T^{k}(u^{k}) may be applied to Equation (3) to form the gated end-to-end memory network given by Equation (6) below:

u^{k+1}=o^{k}⊙T^{k}(u^{k})+u^{k}⊙(1−T^{k}(u^{k}) Equation (6)

where ⊙ comprises a dot product function or an elementwise multiplication.

In one embodiment, additional constraints may be placed on W_{T}^{k} and b_{T}^{k}. For example, a global constraint may be applied such that all the weight matrices W_{T}^{k} and bias terms b_{T}^{k} are shared across different hops (e.g., W_{T}¹=W_{T}²= . . . =W_{T}^{K} and b_{T}¹=b_{T}²= . . . =b_{T}^{K}). Another constraint that may be applied may be a hop-specific constraint such that each hop has its specific weight matrix W_{T}^{k} and bias term b_{T}^{k} for k ∈ [1, K] and the weight matrix W_{T}^{k} and bias term b_{T}^{k} are optimized independently.

As can be seen by Equation (6), the gate mechanism may determine how the current state of the memory controller and the output affect a subsequent, or updated, state of the memory controller 104. In a simple example, when T^{k}(u^{k})=1, then the next state u^{k+1} of the memory controller 104 would be controlled by the output o^{k}. Conversely, when T^{k}(u^{k})=0, then the next state u^{k+1} of the memory controller 104 would be controlled by the current state u^{k} of the memory controller 104. In one embodiment, the values of T^{k}(u^{k}) may be any value between 0 and 1.

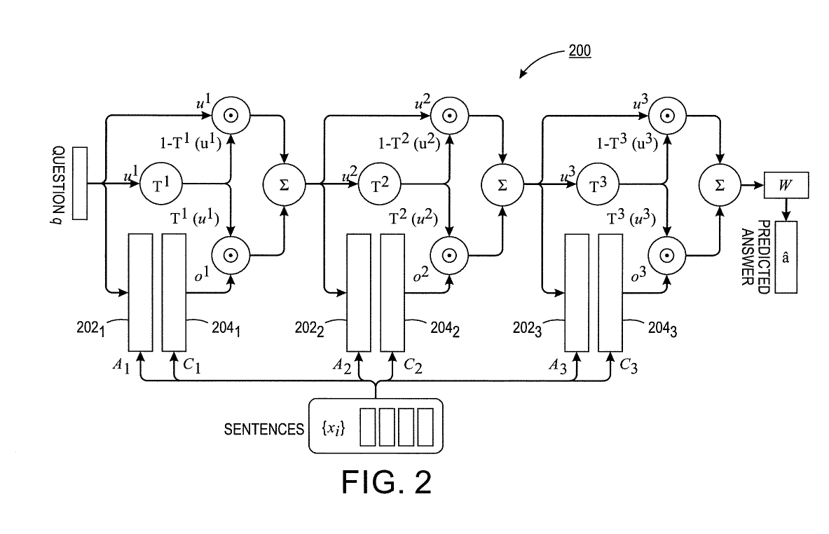

FIG. 2 illustrates an example visualization 200 of the gate mechanism that uses three hops. In one embodiment, a question q is inputted on the left hand side and encoded by the embedding matrix B into a state u^{k}. Training sentences can be broken down into the plurality of input contexts x₁, . . . , xᵢ and transformed into input memory cells 202₁-202₃ and output memory cells 204₁-204₃ using the embedding matrices A₁-A₃ and C₁-C₃, respectively. The gate mechanism T^{k}(u^{k}) is shown being applied to both u^{k} and o^{k} using the dot produce function ⊙ at each hop. A softmax of W (that is a function of the iteration of three hops that were calculated) is calculated to produce a predicted answer â.

The softmax function may be also referred to as a normalized exponential function that transforms a K-dimensional vector of arbitrary real values to a K-dimensional vector of real values in the range of (0,1) that add up to 1. The softmax function may be used to represent a probability distribution over K different possible outcomes. Thus, the answer â may be selected to be the value that has the highest probability within the distribution.

As described above, the printing apparatus 100 may be located in an environment that is not controlled. In other words, the environment may have fluctuations in temperature, humidity level and the like. For example, the environment may be an office building that does not have air conditioning or a temperature control device. As a result, changes in the environment may negatively impact the performance of the printing apparatus 100 using a traditional feeding system.

One example of training using the above Equations (1)-(6) used 10 percent of a training set to form a validation set for hyperparameter tuning. In one embodiment, position encoding, adjacent weight tying and temporal encoding with 10 percent random noise were used. A learning rate η was initially assigned a value of 0.0005 with exponential decay applied every 25 epochs by η/2 until 100 epochs were reached. In one embodiment, linear start was used. With linear start, the softmax in each memory layer was removed and re-inserted after 20 epochs. Batch size was set to 32 and gradients with an I₂ norm larger than 40 were divided by a scalar to have norm 40. All weights were initialized randomly from a Gaussian distribution with zero mean and σ=0.1 except for the transform gate bias term b_{T}^{k}, which had a mean empirically set to 0.5. Only the most recent 50 sentences were fed into the model as the memory and the number of memory hops was set to 3. The embedding size d was set to 20. In one embodiment, the training was repeated 100 times with different random initializations and the best system based on the validation performance was selected. In one embodiment, when the above training set was used the gated end-to-end memory network of the present disclosure performed better than the non-gated end-to-end memory network.

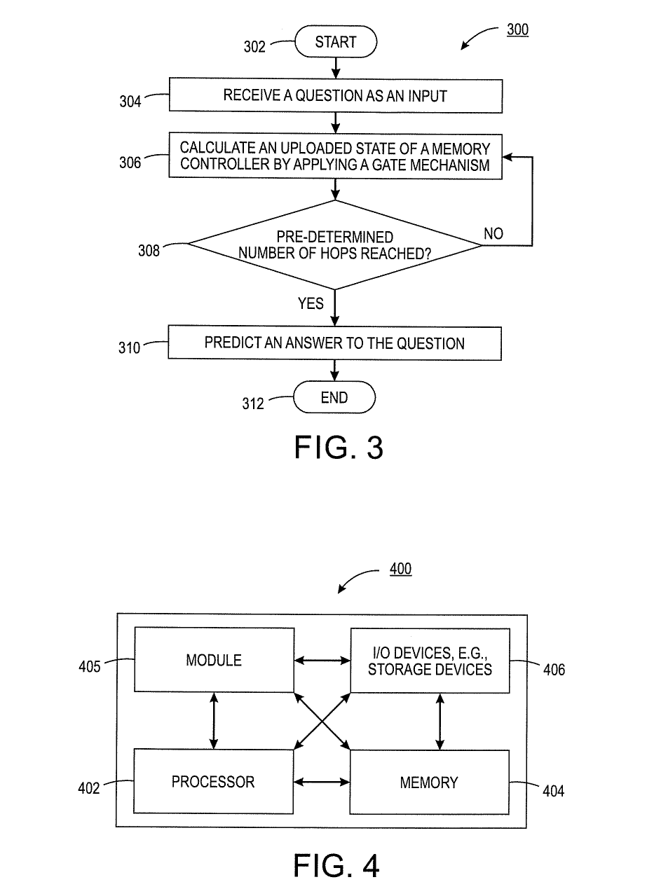

FIG. 3 illustrates a flowchart of an example method 300 for gating an end-to-end memory network. In one embodiment, one or more steps or operations of the method 300 may be performed by the dedicated AS 102 illustrated in FIG. 1 or a computer as illustrated in FIG. 4 and discussed below.

At block 302, the method 300 begins. At block 304, the method 300 receives a question as an input. For example, the question may be input to a dedicated application server for performing natural language processing to produce an answer to the question as an output. The dedicated application server may perform natural language based reasoning tasks, basic deduction, positional reasoning, dialog related tasks, and the like, using a gated end-to-end memory network within the dedicated application server. The input may be a question such as “What language do they speak in France?” In one embodiment, the question may be encoded into its controller state.

In one embodiment, the dedicated application server may be trained with supporting memories that are used to answer the question that is input. A memory controller within the dedicated application server may perform an iterative process over a pre-determined number of hops to access the supporting memories and obtain an answer to the question. In one embodiment, the question and a plurality of input memory cells and output memory cells may be vectorized and processed as described above.

At block 306, the method 300 calculates an updated state of a memory controller by applying a gate mechanism. For example, Equations (4) and (5) may be applied using an iterative process for each state of the memory controller for a pre-determined number of hops. For example, the method 300 may use the question that is encoded into its controller state and additional information from memory that can be used to support the predicted answer. The gate mechanism may be applied to dynamically regulate the interaction between the memory controller and the memory in the dedicated application server. The gate mechanism may regulate the output and the current state of the memory controller to determine how the memory controller is updated for a subsequent, or next state of the memory controller.

At block 308, the method 300 determines if the pre-determined number of hops is reached. The predetermined number of hops may be based on a number of iterations to normalize the predicted answer distribution within an acceptable range. In one example, the predetermined number of hops may be 3. In another example, the predetermined number of hops may be 5. If the answer to block 308 is no, the method 300 may return to block 306 and the next state, or updated state, of the memory controller may be calculated. If the answer to block 308 is yes, the method 300 may proceed to block 310.

At block 310, the method 300 predicts an answer to the question. For example, Equation (4) described above may be used to predict an answer to the question. For example, the dedicated application server may predict the answer to be “French” based on the question “What language do they speak in France?” that was provided as an input.

In one embodiment, the output may be displayed via a user interface. In one embodiment, the output may be transmitted to a user device that is connected to the dedicated application server locally or remotely via a wired or wireless connection. The method 300 ends at block 312.

It should be noted that although not explicitly specified, one or more steps, functions, or operations of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, the use of the term “optional” in the above disclosure does not mean that any other steps not labeled as “optional” are not optional. As such, any claims not reciting a step that is not labeled as optional is not to be deemed as missing an essential step, but instead should be deemed as reciting an embodiment where such omitted steps are deemed to be optional in that embodiment.

FIG. 4 depicts a high-level block diagram of a computer that is dedicated to perform the functions described herein. As depicted in FIG. 4, the computer 400 comprises one or more hardware processor elements 402 (e.g., a central processing unit (CPU), a microprocessor, or a multi-core processor), a memory 404, e.g., random access memory (RAM) and/or read only memory (ROM), a module 405 for gating an end-to-end memory network, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method(s) as discussed above is implemented in a distributed or parallel manner for a particular illustrative example, i.e., the steps of the above method(s) or the entire method(s) are implemented across multiple or parallel computers, then the computer of this figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 405 for gating an end-to-end memory network (e.g., a software program comprising computer-executable instructions) can be loaded into memory 404 and executed by hardware processor element 402 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for gating an end-to-end memory network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for gating an end-to-end memory network, comprising:
receiving, by a processor, a question as an input;
calculating, by the processor, an updated state of a memory controller by applying a gate mechanism to an output based on the input and a current state of the memory controller of the end-to-end memory network, wherein the updated state of the memory controller determines a next read operation of a memory cell of a plurality of memory cells in the end-to-end memory network;
repeating, by the processor, the calculating for a pre-determined number of hops; and
predicting, by the processor, an answer to the question by applying a softmax function to a sum of the output and the updated state of the memory controller of each one of the pre-determined number of hops.

2. The method of claim 1, wherein the gating mechanism determines how the updated state of the memory controller is updated based upon data that is read from the memory cell.

3. The method of claim 2, wherein the gating mechanism of a k^{th} hop (T^{k}) is a function of the current state of the memory controller of the k^{th} hop (u^{k}) comprising:
T^{k}(u^{k})=σ(W_{T}^{k}u^{k}+b_{T}^{k}),
where σ is a sigmoid function, W_{T}^{k} is a hop-specific parameter matrix for the k^{th} hop, and b is a bias term for the k^{th} hop.

4. The method of claim 3, wherein the updated state of the memory controller (u^{k+1}) comprises:
u^{k+1}=o^{k}⊙T^{k}(u^{k})+u^{k}⊙(1−T^{k}(u^{k})),
where o^{k} is the output based on the input and ⊙ comprises a dot product function.

5. The method of claim 4, wherein the output o^{k} comprises a sum over i values of a vector of attention weights (pᵢ) applied to an output memory cell (cᵢ).

6. The method of claim of claim 5, wherein the attention weight comprises a softmax function applied to a transformed matrix of states of the memory controller (u^{T}) applied to an i^{th} input memory cell (mᵢ).

7. The method of claim 6, wherein the input comprises a plurality of inputs, wherein each one of the plurality of inputs is stored in a respective mᵢ.

8. The method of claim 1, wherein each one of the plurality of memory cells stores a word.

9. A non-transitory computer-readable medium storing a plurality of instructions, which when executed by a processor, cause the processor to perform operations for gating an end-to-end memory network comprising:
receiving a question as an input;
calculating an updated state of a memory controller by applying a gate mechanism to an output based on the input and a current state of the memory controller of the end-to-end memory network, wherein the updated state of the memory controller determines a next read operation of a memory cell of a plurality of memory cells in the end-to-end memory network;
repeating the calculating for a pre-determined number of hops; and
predicting an answer to the question by applying a softmax function to a sum of the output and the updated state of the memory controller of each one of the pre-determined number of hops.

10. The non-transitory computer-readable medium of claim 9, wherein the gating mechanism determines how the updated state of the memory controller is updated based upon data that is read from a memory cell.

11. The non-transitory computer-readable medium of claim 10, wherein the gating mechanism of a k^{th} hop (T^{k}) is a function of the current state of the memory controller of the k^{th} hop (u^{k}) comprising:
T^{k}(u^{k})=σ(W_{T}^{k}u^{k}+b_{T}^{k}),
where σ is a sigmoid function, W_{T}^{k} is a hop-specific parameter matrix for the k^{th} hop, and b is a bias term for the k^{th} hop.

12. The non-transitory computer-readable medium of claim 11, wherein the updated state of the memory controller (u^{k+1}) comprises:
u^{k+1}=o^{k}⊙T^{k}(u^{k})+uₖ⊙(1−T^{k}(u^{k})),
where o^{k} is the output based on the input and ⊙ comprises a dot product function.

13. The non-transitory computer-readable medium of claim 12, wherein the output o^{k} comprises a sum over i values of a vector of attention weights (pᵢ) applied to an output memory cell (cᵢ).

14. The non-transitory computer-readable medium of claim 13, wherein the attention weight comprises a softmax function applied to a transformed matrix of states of the memory controller (u^{T}) applied to an i^{th} input memory cell (mᵢ).

15. The non-transitory computer-readable medium of claim 14, wherein the input comprises a plurality of inputs, wherein each one of the plurality of inputs is stored in a respective mᵢ.

16. The non-transitory computer-readable medium of claim 9, wherein each one of the plurality of memory cells stores a word.

17. A method for gating an end-to-end memory network, comprising:
receiving, by a processor, a question as an input;
dividing, by the processor, the question into a plurality of input contexts that are stored in a plurality of input memory cells and a plurality of output memory cells;
calculating, by the processor, an attention weight of each one of the plurality of input memory cells based on a transform matrix of a current state of a memory controller and the each one of the plurality of input memory cells;
calculating, by the processor, an output based on a sum of the attention weight of the each one of the plurality of input memory cells and each one of the plurality of output memory cells;
calculating, by the processor, an updated state of the memory controller by applying a gate mechanism to the output and the current state of the memory controller of the end-to-end memory network, wherein the updated state of the memory controller determines a next read operation of the end-to-end memory network;
repeating, by the processor, the calculating the updated state of the memory controller for a pre-determined number of hops; and
predicting, by the processor, an answer to the question by applying a softmax function to a sum of the output and the updated state of the memory controller of each one of the pre-determined number of hops.

18. The method of claim 17, wherein the gating mechanism determines how the updated state of the memory controller is updated based upon data that is read from a memory cell.

19. The method of claim 18, wherein the gating mechanism of a k^{th} hop (T^{k}) is a function of the current state of the memory controller of the k^{th} hop (u^{k}) comprising:
T^{k}(u^{k})=σ(W_{T}^{k}u^{k}+b_{T}^{k}),
where σ is a sigmoid function, W_{T}^{k} is a hop-specific parameter matrix for the k^{th} hop, and b is a bias term for the k^{th} hop.

20. The method of claim 19, wherein the updated state of the memory controller (u^{k+1}) comprises:
u^{k+1}=o^{k}⊙T^{k}(u^{k})+u^{k}⊙(1−T^{k}(u^{k})),
where o^{k} is the output based on the input and ⊙ comprises a dot product function.
